(19) United States
(12) Patent Application Publication
(10) Pub. No.: US 2026/0061996 A1
(43) Pub. Date: Mar. 5, 2026

(54) DYNAMIC ENGAGEMENT ENVELOPE FOR ACTIVATION OF A DRIVER INITIATED EVASIVE STEERING MANEUVER

(71) Applicant: GM GLOBAL TECHNOLOGY OPERATIONS LLC, Detroit, MI (US)

(72) Inventors: Milad Jalaliyazdi, Richmond Hill (CA); Tetyana V. Mamchuk, Novi, MI (US); Reza Zarringhalam, Whitby (CA); Zhiyuan Du, Troy, MI (US); Harsh Ketan Patel, New Hudson, MI (US); Jeffrey S. Parks, Ann Arbor, MI (US); Paul A. Adam, Milford, MI (US)

(73) Assignee: GM GLOBAL TECHNOLOGY OPERATIONS LLC, Detroit, MI (US)

(21) Appl. No.: 18/817,346

(22) Filed: Aug. 28, 2024

(51) Int. Cl. B60W 30/09; B60W 10/04; B60W 10/18; B60W 10/20

(52) U.S. Cl. CPC B60W 30/09; B60W 10/04; B60W 10/18; B60W 10/20; B60W 2420/403; B60W 2540/18; B60W 2552/15; B60W 2552/20; B60W 2552/53; B60W 2554/4041; B60W 2710/202; B60W 2720/125

(57) ABSTRACT

In an exemplary embodiment, method and systems are provided for completing an evasive steering maneuver for a vehicle around an object, including detecting the object, via detection sensors of the vehicle; obtaining, via input sensors of the vehicle, an input reflecting a driver's intent to initiate the evasive steering maneuver for the vehicle around the object; obtaining, via additional sensors, additional sensor data pertaining to operation of the vehicle and further pertaining to a roadway on which the vehicle is travelling; performing, via a processor of the vehicle, a plurality of assessors for the vehicle, each of the plurality of assessors pertaining to different conditions pertaining to the evasive steering maneuver, using the additional sensor data; and selectively completing the evasive steering maneuver, automatically in accordance with instructions provided by the processor, based on the plurality of assessors and the different conditions pertaining thereto.

### INTRODUCTION

The technical field generally relates to platforms such as vehicles and, more specifically, to methods and systems for implementing an evasive steering maneuver when requested by a driver of the vehicle.

Many vehicles today have some form of automatic steering capability. However, in certain situations, such techniques may not always be optimal, including for implementing an evasive steering maneuver that is initiated by a driver of the vehicle.

Accordingly, it is desirable to provide improved methods and systems for implementing evasive steering maneuvers for a vehicle when initiated by a driver of the vehicle.

### SUMMARY

In accordance with an exemplary embodiment, a method of completing an evasive steering maneuver for a vehicle around an object is provided, the method including detecting the object, via one or more detection sensors of the vehicle; obtaining, via one or more input sensors of the vehicle, an input reflecting a driver's intent to initiate the evasive steering maneuver for the vehicle around the object; obtaining, via one or more additional sensors, additional sensor data pertaining to operation of the vehicle and further pertaining to a roadway on which the vehicle is travelling; performing, via a processor of the vehicle, a plurality of assessors for the vehicle, each of the plurality of assessors pertaining to different conditions pertaining to the evasive steering maneuver, using the additional sensor data; and selectively completing the evasive steering maneuver, automatically in accordance with instructions provided by the processor, based on the plurality of assessors and the different conditions pertaining thereto.

Also in an exemplary embodiment, the step of selectively completing the evasive steering maneuver includes selectively completing the evasive steering maneuver automatically in accordance with instructions provided by the processor, based on the plurality of assessors and the different conditions pertaining thereto, by instructions provided by the processor that are implemented via a steering system, a drive system, and a braking system of the vehicle.

Also in an exemplary embodiment, the object includes one or more other vehicles in proximity to the vehicle.

Also in an exemplary embodiment, the object includes one or more vulnerable road users (VRU) including one or more pedestrians, cyclists, or animals.

Also in an exemplary embodiment, the step of obtaining the input reflecting the driver's intent to initiate the evasive steering maneuver for the vehicle around the object is obtained via one or more steering sensors of the vehicle, based on the driver's engagement of a steering wheel of the vehicle.

Also in an exemplary embodiment, the step of obtaining the input reflecting the driver's intent to initiate the evasive steering maneuver for the vehicle around the object is obtained via one or more cameras configured to capture images of one or more actions taken by a driver of the vehicle.

Also in an exemplary embodiment, the step of performing the plurality of assessors includes performing, via the processor, each of the following assessors: an allowable passing window assessor, a vehicle dynamics assessor, and one or more additional assessors; and the step of selectively completing the evasive steering maneuver includes selectively automatically completing the evasive steering maneuver in accordance with instructions provided by the processor, based on each of the allowable passing window assessor, the vehicle dynamics assessor, and the one or more additional assessors.

Also in an exemplary embodiment, the step of performing the plurality of assessors includes performing, via the processor, each of the following assessors: an allowable passing window assessor; a vehicle dynamics assessor; a lane topology assessor; a vulnerable road user (VRU) assessor; a timely intent assessor; and a scene actor assessor; and the step of selectively completing the evasive steering maneuver includes selectively automatically completing the evasive steering maneuver in accordance with instructions provided by the processor, based on each of the allowable passing window assessor, the vehicle dynamics assessor, the lane topology assessor, the vulnerable road user (VRU) assessor, the timely intent assessor, and the scene actor assessor.

Also in an exemplary embodiment, the evasive steering maneuver is automatically completed via instructions provided by the processor if, and only if, a passing indication is provided by each of the allowable passing window assessor, the vehicle dynamics assessor, the lane topology assessor, the vulnerable road user (VRU) assessor, the timely intent assessor, and the scene actor assessor.

Also in an exemplary embodiment, the step of selectively completing the evasive steering maneuver includes selectively automatically completing the evasive steering maneuver in accordance with instructions provided by the processor, based also on lane markings along the roadway, including as to whether the lane markings provide that passing is allowed on one or more adjacent lanes.

Also in an exemplary embodiment, the step of selectively completing the evasive steering maneuver includes selectively automatically completing the evasive steering maneuver in accordance with instructions provided by the processor, based also on a time to contact (TTC) window between the vehicle and the detected object that is dependent upon a speed of the vehicle as well as one or more potential contact warnings that are provided by one or more safety systems of the vehicle.

Also in an exemplary embodiment, the step of selectively completing the evasive steering maneuver includes selectively automatically completing the evasive steering maneuver in accordance with instructions provided by the processor, based also on assessment of one or more side threats to the vehicle as it would undertake the evasive steering maneuver, including as to whether any additional vehicles or other objects, along their respective current trajectories, would be likely to interfere with the evasive steering maneuver for the vehicle.

Also in an exemplary embodiment, the step of selectively completing the evasive steering maneuver includes selectively automatically completing the evasive steering maneuver in accordance with instructions provided by the processor, based also on both: a total required lateral acceleration of the vehicle, calculated by the processor as a summation of an evasion lateral acceleration required to evade the object, added to a lane keeping lateral acceleration required to maintain the vehicle in an intended lane of travel; and a peak steering torque required to execute the evasive steering maneuver, calculated by the processor based on both the total required lateral acceleration along with a de-boost curve for an electric power steering system for the vehicle.

Also in an exemplary embodiment, the step of selectively completing the evasive steering maneuver includes selectively automatically completing the evasive steering maneuver in accordance with instructions provided by the processor, based also on executing a vulnerable road user (VRU) assessor, including by doing the following, via the processor: calculating an estimated path of the vehicle; drawing a tangential line that is tangential to the estimated path of the vehicle; determining, an estimated path error of the vehicle; calculating, via the processor, a distance from a vulnerable road user to the tangential line; and engaging in completing the evasive steering maneuver, if and only if the distance from the vulnerable road user to the tangential line is less than the estimated path error for the vehicle.

In another exemplary embodiment, a system is provided for completing an evasive steering maneuver for a vehicle around an object, the system including: one or more detection sensors of the vehicle that are configured for detecting the object; one or more input sensors that are configured for obtaining an input reflecting a driver's intent to initiate the evasive steering maneuver for the vehicle around the object; one or more additional sensors that are configured for obtaining additional sensor data pertaining to operation of the vehicle and further pertaining to a roadway on which the vehicle is travelling; and a processor that is coupled to the one or more detection sensors, the one or more input sensors, and the one or more additional sensors, the processor configured to at least facilitate: performing a plurality of assessors for the vehicle, each of the plurality of assessors pertaining to different conditions pertaining to the evasive steering maneuver, using the additional sensor data; and selectively completing the evasive steering maneuver, automatically in accordance with instructions provided by the processor, based on the plurality of assessors and the different conditions pertaining thereto.

Also in an exemplary embodiment, the processor is further configured to at least facilitate performing the plurality of assessors by performing each of the following assessors: an allowable passing window assessor, a vehicle dynamics assessor, and one or more additional assessors; and selectively automatically completing the evasive steering maneuver in accordance with instructions provided by the processor, based on each of the allowable passing window assessor, the vehicle dynamics assessor, and the one or more additional assessors.

Also in an exemplary embodiment, the processor is further configured to at least facilitate performing the plurality of assessors by performing each of the following assessors: an allowable passing window assessor; a vehicle dynamics assessor; a lane topology assessor; a vulnerable road user (VRU) assessor; a timely intent assessor; and a scene actor assessor; and selectively automatically completing the evasive steering maneuver in accordance with instructions provided by the processor, based on each of the allowable passing window assessor, the vehicle dynamics assessor, the lane topology assessor, the vulnerable road user (VRU) assessor, the timely intent assessor, and the scene actor assessor.

Also in an exemplary embodiment, the processor is further configured to at least facilitate selectively automatically completing the evasive steering maneuver in accordance with instructions provided by the processor, based also on both: a total required lateral acceleration of the vehicle, calculated by the processor as a summation of an evasion lateral acceleration required to evade the object, added to a lane keeping lateral acceleration required to maintain the vehicle in an intended lane of travel; and a peak steering torque required to execute the evasive steering maneuver, calculated by the processor based on both the total required lateral acceleration along with a de-boost curve for an electric power steering system for the vehicle.

Also in an exemplary embodiment, the processor is further configured to at least facilitate selectively automatically completing the evasive steering maneuver in accordance with instructions provided by the processor, based also on executing a vulnerable road user (VRU) assessor, including by doing the following: calculating an estimated path of the vehicle; drawing a tangential line that is tangential to the estimated path of the vehicle; determining, an estimated path error of the vehicle; calculating, via the processor, a distance from the VRU to the tangential line; and engaging in completing the evasive steering maneuver, if and only if the distance from the VRU to the tangential line is less than the estimated path error for the vehicle.

In another exemplary embodiment, a vehicle is provide that includes a steering system; a drive system; a braking system; one or more detection sensors that are configured for detecting an object in proximity to the vehicle; one or more input sensors that are configured for obtaining an input reflecting a driver's intent to initiate an evasive steering maneuver for the vehicle around the object; one or more additional sensors that are configured for obtaining additional sensor data pertaining to operation of the vehicle and further pertaining to a roadway on which the vehicle is travelling; and a processor that is coupled to the one or more detection sensors, the one or more input sensors, the one or more additional sensors, the steering system, the drive system, and the braking system, the processor configured to at least facilitate performing a plurality of assessors for the vehicle, each of the plurality of assessors pertaining to different conditions pertaining to the evasive steering maneuver, using the additional sensor data; and selectively completing the evasive steering maneuver, automatically in accordance with instructions provided by the processor and that are executed by the steering system, the drive system, and the braking system, based on the plurality of assessors and the different conditions pertaining thereto.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for implementing an evasive steering maneuver that is initiated by a driver of the vehicle, in accordance with exemplary embodiments;

FIG. 2 is a flowchart of a process for implementing an evasive steering maneuver that is initiated by a driver of the vehicle, and that can be implemented in connection with the vehicle of FIG. 1, including the control system thereof, in accordance with an exemplary embodiment; and

FIGS. 3-11 depict exemplary illustrations of implementations of the process of FIG. 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

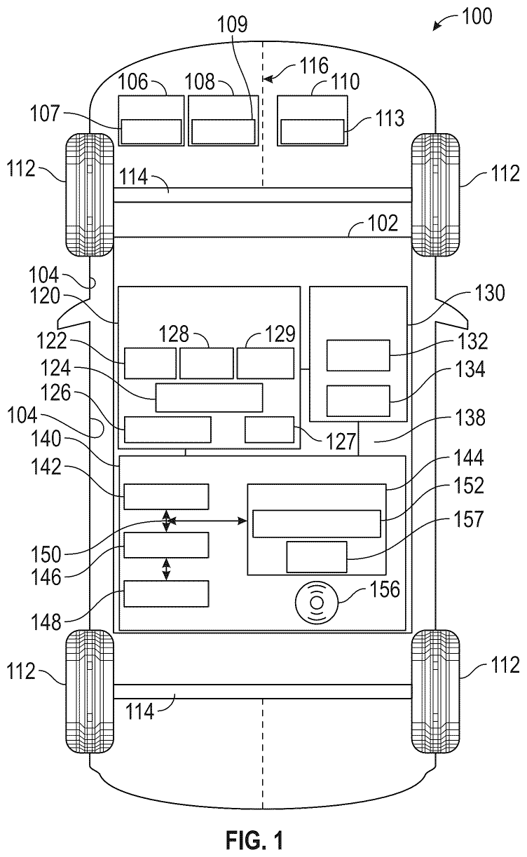

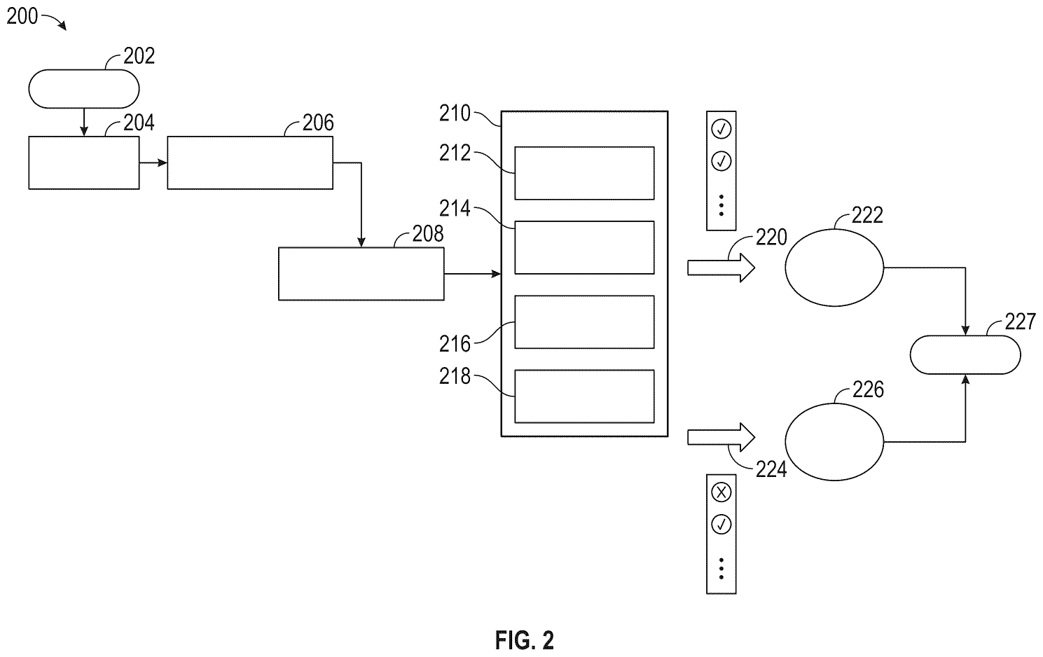

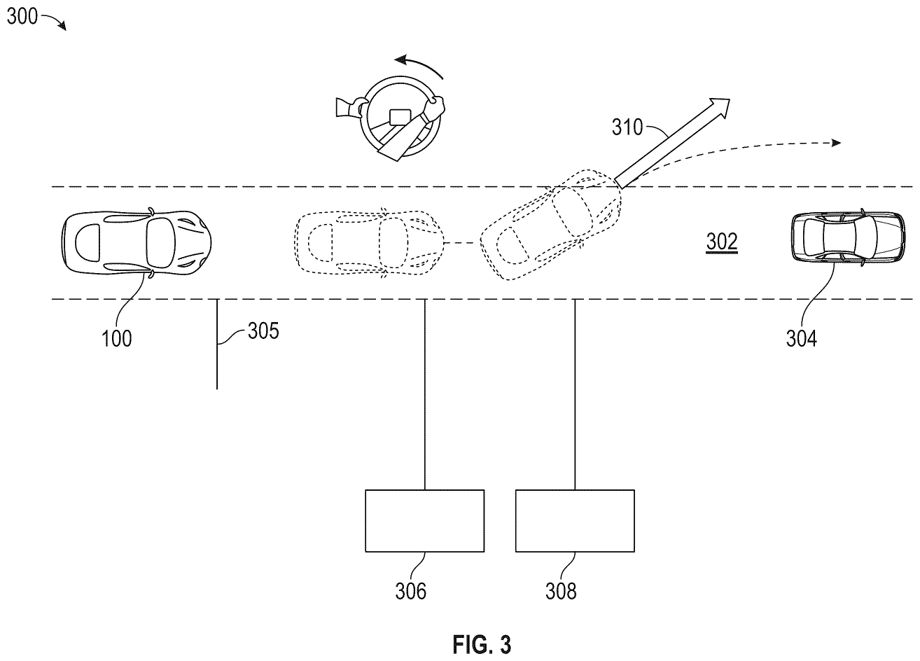

FIG. 1 illustrates a vehicle 100, according to an exemplary embodiment. As described in greater detail further below, the vehicle 100 includes, among other components, a control system 102 for implementing an evasive steering maneuver that is initiated by a driver of the vehicle, in accordance with exemplary embodiments. As described in greater detail further below in connection with FIG. 1 as well as the process 200 of FIG. 2 and the implementations of FIGS. 3-11, in various embodiments the control system 102 utilizes a variety of different vehicle assessors and vehicle sensor data for selectively implementing the automatic completion of the evasive steering maneuver that has been initiated by a driver of the vehicle.

In various embodiments, the vehicle 100 comprises an automobile, such as any one of a number of different types of automobiles, such as, for example, a sedan, a wagon, a truck, sport utility vehicle (SUV), or the like. In certain embodiments, the vehicle 100 may also comprise a motorcycle or other vehicle, such as aircraft, spacecraft, watercraft, and so on, and/or one or more other types of mobile platforms (e.g., a robot and/or another mobile platform).

In accordingly with an exemplary embodiment, the vehicle 100 also refers to the “host vehicle” as referenced herein, including the Specification as well as the Claims. Also in accordance with an exemplary embodiment, the terms “passing” (e.g., in a passing action, passing maneuver, and so on), “overtaking” (e.g., in an action or maneuver to overtake another vehicle), and similar terms refer to action (i.e., maneuver) in which the vehicle 100 is to pass and overtake another vehicle that is detected along the same roadway as the vehicle 100, and including evasive steering maneuvers in which the driver initiates the action (e.g., by engaging the steering wheel 109 of the vehicle 100) and the control system 102 completes the action by completing the evasive steering maneuver, including by overtaking the other vehicle by initially changing lanes, then passing the other vehicle. In certain embodiments, the vehicle 100 may then ultimately return to the same lane as before in a position that is ahead of the other vehicle and/or take one or more control actions.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks, motorcycles, and certain other vehicles).

A drive system 110 is mounted on the chassis 116, and drives the wheels 112, for example via axles 114. In certain embodiments, the drive system 110 comprises a propulsion system having a motor 113 (e.g. that includes, in various embodiments, one or more combustion engines, electric motors, or the like).

As depicted in FIG. 1, the vehicle also includes a braking system 106 and a steering system 108 in various embodiments. In exemplary embodiments, the braking system 106 controls braking of the vehicle 100 using braking components that are controlled via inputs provided by a driver (e.g., via a brake pedal 107) in certain situations, and in certain situations via a control system (including the control system 102).

Also in exemplary embodiments, the steering system 108 controls steering of the vehicle 100 via steering components that are controlled via inputs provided by a driver (e.g., via a steering wheel 109) in certain situations, and also in certain situations automatically via a control system (including the control system 102).

In the embodiment depicted in FIG. 1, the control system 102 is coupled to the braking system 106, the steering system 108, and the drive system 110, and controls operation and functionality thereof. Also in various embodiments, the control system 102 provides for implementing an evasive steering maneuver that is initiated by a driver of the vehicle 100, in accordance with the process 200 as depicted in FIG. 2 and the implementations of FIGS. 3-11 and as described further below in connection therewith.

Also as depicted in FIG. 1, in various embodiments, the control system 102 includes a sensor array 120, a display 130, and a controller 140, as described in greater detail below.

In various embodiments, the sensor array 120 includes various sensors that obtain sensor data as to inputs that are used by the control system 102 for implementing an evasive steering maneuver that is initiated by a driver of the vehicle 100, in exemplary embodiments. In the depicted embodiment, the sensor array 120 includes one or more steering sensors 122, detection sensors 124, cameras 126, speed sensors 127, and accelerometers 128. In certain embodiments, the sensor array 120 may further include one or more other sensors 129 (e.g., as to receiving other inputs, and/or obtaining various operating parameters, environmental conditions, and the like).

In various embodiments, the steering sensors 122 detect the driver's engagement of the steering wheel 109, and including the driver's intent to steering the vehicle 100 (including in evasive steering maneuvers as described herein). In certain embodiments, the steering sensors 122 may be part of and/or coupled to one or more components of the steering system 108, such as the steering wheel 109 thereof (and/or in certain embodiments a steering column of the steering system 108, and so on). In certain embodiments, the steering sensors 122 may be considered input sensors for obtaining this intent of the driver for the evasive steering maneuvers. In certain embodiments, this driver intent may also be obtained from one or more other input sensors (e.g., in detecting a voice command and/or other command of the driver, and/or via one of the cameras 126 mentioned below, and so on).

In various embodiments, the detection sensors 124 detect other vehicles and/or other objects in proximity to the vehicle 100. In certain embodiments, the detection sensors 124 include one or more Lidar, radar, sonar, and/or other detection sensors.

Also in various embodiments, the cameras 126 are configured to obtain visual inputs as to a roadway on which the vehicle 100 is travelling, including other vehicles and other objects in proximity to the vehicle 100. In certain embodiments, the cameras 126 also obtain information as to a driver of the vehicle 100, including gestures of hands or figures and/or other movements of the driver (e.g., for obtaining information as to the intent of the driver, including for evasive steering maneuvers in certain embodiments). In certain embodiments, the cameras 126 may be part of and/or coupled to one or coupled to one or more of the detection sensors 124.

In various embodiments, the speed sensors 127 measure a speed of the vehicle 100. In certain embodiments, the speed sensors 127 comprise one or more wheel speed sensors that are part of or coupled to one or more of the wheels 112.

In various embodiments, the accelerometers 128 measure an acceleration of the vehicle 100.

In various embodiments, each of the sensors of the sensor array 120 are disposed within or on the vehicle 100, such as on the body 104 and/or on or more other components thereof.

In various embodiments, the display 130 provides information for the driver, including as to the implementing of an evasive steering maneuver by the control system 102 of the vehicle 100. As depicted in FIG. 1, in certain embodiments, the display 130 includes an audio component 132 (including one or more speakers) in addition to a visual (or video) component 134 (including one or more display screens). In certain embodiments, the display 130 may also include, among other possibilities, a display screen, or head up display, or a projector that projects images on items, and/or in other embodiments controlling the light of or around the button, knob, or other input device, such as by blinking, rotating, and/or indicating to the user which button, or the like); and/or one or more other types of apparatus for providing indications, such as one or more haptic indications (e.g., rotating the steering wheel), and/or blinking lights and/or buttons, and so on.

In various embodiments, the controller 140 is coupled to the sensor array 120 and the display 130, in addition to the braking system 106, the steering system 108, and the drive system 110. Also in various embodiments, the controller 140 receives sensor data from the sensor array 120, interprets and processes the sensor data, provides instructions to the braking system 106, the steering system 108, and the drive system 110 for implementing an evasive steering maneuver that is initiated by a driver of the vehicle 100 as determined using the sensor data, and further provides instructions for the display 130 to provide notifications during such events. In various embodiments, the controller 140 may be further coupled to various other vehicle components (e.g., including a navigation system, and other non-depicted components) and controls operation thereof.

In various embodiments, the controller 140 provides these functions in accordance with the steps of the process 200 that is depicted in FIG. 2 and described in greater detail further below in connection therewith and further in connection with the implementations of FIGS. 3-11, also a described in greater detail further below.

As depicted in FIG. 1, in various embodiments, the controller 140 comprises a computer system (also referred to herein as computer system 140), and includes a processor 142, a memory 144, an interface 146, a storage device 148, and a computer bus 150.

The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 of FIG. 2 and implementations of FIGS. 3-11 and as described further below in connection therewith.

The memory 144 can be any type of suitable memory, including various types of non-transitory computer readable storage medium. In certain examples, the memory 144 is located on and/or co-located on the same computer chip as the processor 142. In the depicted embodiment, the memory 144 stores the above-referenced program 152 along with stored values 157 (e.g., look-up tables, thresholds, and/or other values with respect to the process 200).

The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 of FIG. 2 and implementations of FIGS. 3-11 and as described further below in connection therewith. In another exemplary embodiment, the program product may be directly stored in and/or otherwise accessed by the memory 144 and/or a disk (e.g., disk 156), such as that referenced below.

The bus 150 serves to transmit programs, data, status and other information or signals between the various components of the computer system of the controller 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a flowchart of a process 200 for implementing an evasive steering maneuver that is initiated by a driver of a vehicle, in accordance with an exemplary embodiment. In various embodiments, the process 200 can be implemented in connection with the vehicle 100 of FIG. 1, including the control system 102 thereof. The process 200 will also be described further below in connection with FIGS. 3-11, which depict exemplary illustrations of certain steps of the process 200.

As depicted in FIG. 2, in various embodiments the process 200 begins at 202. In certain embodiments, the process 200 begins when the vehicle 100 is being driven by a driver during a current vehicle drive. In various embodiments, the steps of the process 200 continue, preferably continuously, throughout the duration of the vehicle drive.

In various embodiments, sensor data is obtained (step 204). Specifically, in certain embodiments, sensor data is obtained from each of the sensors of the sensor array 120 of FIG. 1, including as to user inputs from a driver of the vehicle 100 as to steering of the vehicle 100 along with any requests for or initiation of an evasive steering maneuver (via the steering sensors 122 and/or the cameras 126), in addition to operating parameters of the vehicle 100 including a velocity and acceleration thereof (via speed sensors 127 and accelerometers 128, respectively), along with detection and information pertaining to one or more other vehicles or other objects in proximity to the vehicle 100 (via the detection sensors 124 and/or cameras 126), in addition to information as to traffic and conditions of the roadway, and so on.

In various embodiments, an allowable passing window assessor is implemented (step 206). In various embodiments, the processor 142 of FIG. 1 implements the allowable passing window assessor, using the sensor data of step 204, in determining an acceptable window of time and/or distance for the vehicle 100 (i.e., the host vehicle) to pass one or more other vehicles on the roadway in which the vehicle 100 is travelling. In various embodiments, the allowable passing window assessor determines an allowable time to contact (TTC) window in which the vehicle 100 can safely pass the detected other vehicle(s) without contacting the other vehicle(s). In various embodiments, the processor 142, via the allowable passing window assessor also determines whether the vehicle 100 is currently positioned within the allowable passing window, based on the sensor data.

Also in various embodiments, a host dynamics assessor is implemented (step 208). In various embodiments, the processor 142 of FIG. 1 implements the host dynamics assessor, using the sensor data of step 204, in determining a speed and acceleration (including a lateral acceleration) of the vehicle 100 (i.e., using sensor data from the speed sensors 127 and accelerometers 128 of FIG. 1). In various embodiments, the processor 142 implements the host dynamics sensor of step 208 in determining whether the vehicle 100 is in position to generate sufficient speed and acceleration to successfully pass the detected other vehicle 100. In certain embodiments, these determinations are based not only on the speed and lateral acceleration of the vehicle 100, but also on the speed and/or acceleration of the detected other vehicle, as well as on the lane curvature of the roadway (e.g., based on the sensor data from the detection sensors 124 and/or the cameras 126, and so on).

Also in various embodiments, additional assessors are also implemented, as referenced in FIG. 2 as a combined step (or sequence of steps) 210. Specifically, in various embodiments, during combined step 210, the following additional assessors are implemented: a lane topology assessor (step 212); a vulnerable road user (VRU) assessor (step 214); a timely intent assessor (step 216); and a scene actor assessor (step 218). In various embodiments, each of these additional assessors are implemented via the processor 142 of FIG. 1 using the sensor data (e.g., of step 204).

In various embodiments, the lane topology assessor of step 212 analyzes the topology and features of the roadway in which the vehicle 100 is travelling. In certain embodiments, the lane topology assessor analyzes a surface of the roadway, including conditions that would affect a coefficient of friction thereof. For example, in various embodiments, the coefficient of friction is estimated based on a surface material of the roadway (e.g., asphalt, gravel, dirt, or the like), along with weather and other environmental conditions (e.g., rain, sleet, snow, or the like). In certain embodiments, the curvature, incline, speed limits, and/or other features of the roadway may also be taken into consideration.

In various embodiments, the VRU assessor of step 214 analyzes any pedestrians, bicyclists, animals, and/or other potentially vulnerable users of the roadway (e.g., that may be travelling along and/or crossing the roadway, and so on). In certain embodiments, the VRU assessor analyzes the sensor data to help ensure that such vulnerable users would not be contacted by the vehicle 100 and/or otherwise affected as the vehicle 100 overtakes the detected other vehicle in the evasive passing maneuver.

In various embodiments, the timely intent assessor of step 216 analyzes a timeliness of the driver's intent to pass the detected other vehicle. In various embodiments, the timely intent assessor utilizes the sensor data to determine whether the timing of the driver's intent to pass the other vehicle aligns with the allowable passing window of step 206 (i.e., such that the intent is not coming too early or too late to successfully complete the intended passing maneuver).

In various embodiments, the scene action assessor of step 218 analyzes the actions of one or more actors on or nearby the roadway, that may affect the desired steering maneuver. For example, in various embodiments, the actors may include the other vehicle that is to be passed, along with any other nearby vehicles, pedestrians, bicyclists, animals, or the like.

In various embodiments, as part of the combined step 210 referenced above, the processor 142 determines whether each of the assessors of steps 206, 208, 212, 214, 216, and 218 have resulted in a passing or failing condition. Specifically, in an exemplary embodiment, a passing condition for a particular assessor means that the conditions analyzed in the particular assessor are conducive to a successful evasive passing maneuver of the vehicle 100 around the other detected vehicle. Conversely, also in an exemplary embodiment, a failing condition for a particular assessor means that the conditions analyzed in the particular assessor are not conducive to a successful evasive passing maneuver of the vehicle 100 around the other detected vehicle.

In various embodiments, if it is determined that each of the assessors of steps 206, 208, 212, 214, 216, and 218 have resulted in a passing condition, then a determination is made at step 220 to implement the desired evasive passing maneuver. In various embodiments, this determination is made by the processor 142 of FIG. 1. Also in various embodiments, the processor 142 consequently implements the evasive passing maneuver (step 222), including by providing instructions to the steering system 108, the drive system 110, and the braking system 106 that execute the instructions to complete the desired evasive passing maneuver. In various embodiments, as discussed above, the evasive passing maneuver includes the vehicle 100 overtaking and passing the detecting other vehicle using another lane. In certain embodiments, the vehicle 100 may then ultimately return to the same lane as before in a position that is ahead of the other vehicle and/or take one or more control actions. Also as discussed above, in various embodiments, the evasive passing maneuver is implemented after the driver has initiated or otherwise provided a request that manifests an intent to perform the evasive passing maneuver (e.g., via the driver's engagement of the steering wheel 109 of FIG. 1), and further provided that each of the assessors of steps 206, 208, 212, 214, 216, and 218 represent a passing condition. In various embodiments, the process then terminates at step 227.

Conversely, in various embodiments, if it is instead determined that one or more of the 206, 208, 212, 214, 216, and 218 have resulted in a failing condition, then a determination is made at step 224 to not implement the desired evasive passing maneuver. In various embodiments, this determination is made by the processor 142 of FIG. 1. In various embodiments, the process then terminates at the above-mentioned step 227.

As noted above, FIGS. 3-11 depict various implementations of the process 200 of FIG. 2. Specifically, in various embodiments, FIGS. 3-11 depict various implementations of the various assessors of FIG. 2 and functionality thereof, among various other features of the process 200.

With reference first to FIG. 3, an illustration 300 is provided relating to the timely intent assessor of step 216 of FIG. 2, in accordance with an exemplary embodiment. As depicted in FIG. 3, in an exemplary embodiment, the vehicle 100 is depicted travelling along a lane 302 of a roadway, in which a detected other vehicle 304 is also travelling. In certain embodiments, an alert 305 is provided, such as a forward contact alert (FCA) regarding possible contact with the other vehicle 304 (e.g., when the vehicle 100 is on a current path that would result in contact with the other vehicle 304 if steering and/or other changes are not implemented in a timely manner). In certain embodiments, this is provided via the control system 102, for example as part of a safety functionality for the vehicle 100.

Also as depicted in FIG. 3, in various embodiments the driver begins steering the vehicle 100 at 306, and the driver intent for the steering maneuver is detected soon thereafter at 308 (by the control system 102 using the sensor data from the sensor array 120). Also in various embodiments, the driver's steering input results in a new vehicle trajectory 310. In various embodiments, the new vehicle trajectory 310 may result in the vehicle 100 no longer being on a trajectory that would result in contact with the other vehicle 304.

With continued reference to FIG. 3, in various embodiments, dynamic sensor data as to the detected other vehicle 304 is initially classified as a front threat (e.g., when the alert 305 is detected), and is thereafter continually populated to the assessor even when the vehicle 100 moves along the altered trajectory 310 that may no longer be on a path to contact the other vehicle 304 due to the driver's steering input. In various embodiments, this helps to ensure the successful completing of the evasive steering maneuver via instructions provided by the control system 102 of FIG. 1. In addition, in various embodiments, the information as to potential front threats and potential side threats are continuously updated and utilized in concert with one another to further help to complete the evasive steering maneuver and to avoid contact with any nearby other vehicles, vulnerable road users, or other objects.

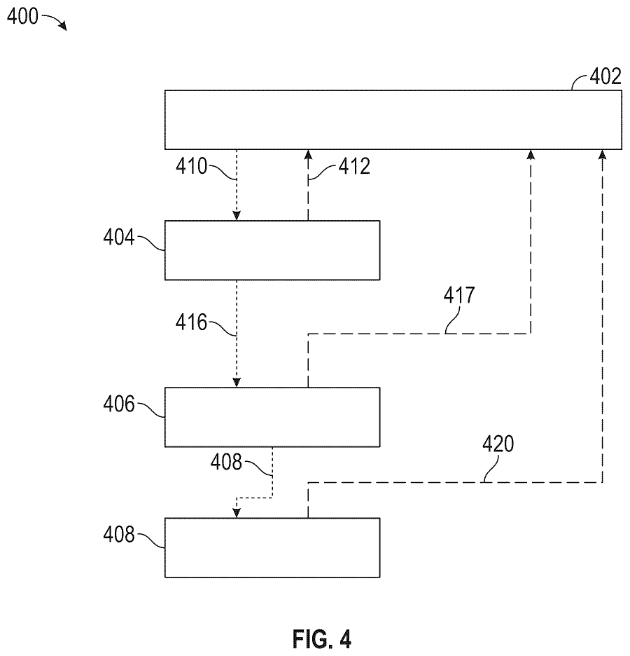

With reference to FIG. 4, a flowchart 400 is provided further relating to the timely intent assessor of step 216 of FIG. 2, in accordance with an exemplary embodiment. As depicted in FIG. 4, in an exemplary embodiment, as the timely intent assessor is implemented the vehicle 100 transitions between the following states: (i) an idle state 402 (e.g., in which the vehicle 100 is operating as usual, without the detection of a threat); (ii) a standby state 404 (e.g., in which the control system 102 is preparing for a possible steering maneuver with respect to a detected threat); (iii) a path planning state 406 (e.g., in which the control system 102 is planning a path of movement for the vehicle 100 to successfully pass the detected threat via an evasive steering maneuver); and (iv) an engagement state 408 (e.g., in which the control system 102 implements the evasive steering maneuver). In various embodiments, the vehicle 100 moves between the various states 402-408 in accordance with instructions by and determinations made by the processor 142 of FIG. 1.

As depicted in FIG. 4, in various embodiments, the vehicle 100 moves from the idle state 402 to the standby state 404 when a confirmed front threat is detected at 410 (e.g., when another vehicle is detected in front of the vehicle 100 that is likely to be contacted by the vehicle 100 under current conditions and states).

Also in various embodiments, the vehicle 100 returns from the standby state 404 to the idle state 402 when the threat is cleared at 414 (e.g., when (A) the threat is cleared, in combination with a predetermined amount of time has passed in which the threat remains cleared; or (B) a threat check of lane drivability has failed, including when a passing lane that would have been used to pass the other vehicle is unavailable, such as when the passing lane is closed or occupied by one or more other vehicles and/or vulnerable road users or objects).

With continued reference to FIG. 4, in various embodiments the vehicle 100 moves from the standby state 404 to the path planning state 406 when an evasive intent of the driver is detected at 416. In various embodiments, this occurs when the driver manifests such intent by initiating a turn via the steering wheel 109 of the vehicle 100. In certain embodiments, the vehicle 100 moves to the path planning state 406 in this manner only upon the further conditions that any side threats have been cleared (e.g., in the passing lane), and further provided that the passing lane is available and suitable for driving for the vehicle 100 (e.g., such that the vehicle 100 can successfully utilize the passing lane for passing the detected other vehicle). Conversely, in various embodiments, the vehicle 100 does not move to the path planning state 406 if a side threat detected, or if the passing lane is unavailable, or both.

As depicted in FIG. 4, in accordance with an exemplary embodiment, when the vehicle 100 is in the path planning state 406 and a path is found at 418 by the control system 102 to successfully implement the evasive turn maneuver, then the vehicle 100 moves to the engagement state 408, as the evasive turn maneuver is completed via instructions provided by the control system 102. Also in various embodiments, once the evasive steering maneuver is completed at 420, the vehicle returns to the idle state 402 as shown in FIG. 4.

Conversely, also as depicted in FIG. 4, when the vehicle 100 is in the path planning state 406 and the control system 102 at 417 does not find a path for successfully executing the desired turn maneuver, then the vehicle 100 moves from the path planning sate 406 directly to the idle state 402 (e.g., without completing the evasive steering maneuver), as shown in FIG. 4 in accordance with an exemplary embodiment.

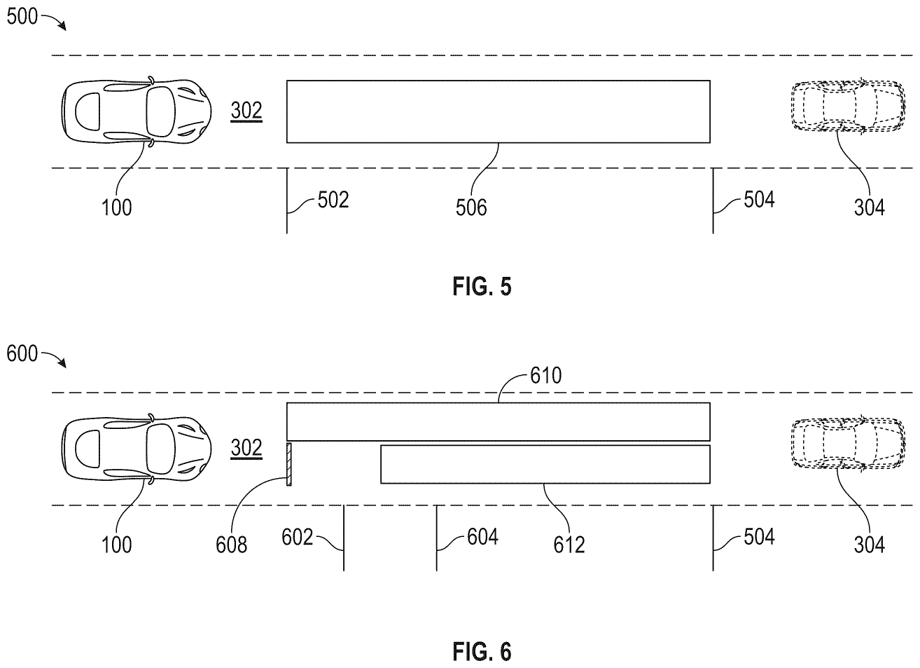

With reference to FIG. 5, an illustration 500 is provided relating to the allowable passing window assessor of step 206 of FIG. 2, in accordance with an exemplary embodiment. As depicted in FIG. 5 in an exemplary embodiment, as the vehicle 100 approaches the other vehicle 304 in the same lane 302, an allowable TTC window 506 is determined, and spans between a maximum TTC 502 and a minimum TTC 504 as illustrated therein. In various embodiments: (i) the maximum TTC 502 refers to a largest feasible amount of time in which the vehicle 100 would be expected to contact the other vehicle 304 under current operating conditions; whereas (ii) the minimum TTC 504 refers to a smallest feasible amount of time in which the vehicle 100 would be expected to contact the other vehicle 304 under current operating conditions.

With continued reference to FIG. 5, in various embodiments, the allowable TTC window 506 comprises a window of time which the evasive steering may successfully be performed, provided that the various other required conditions are met (e.g., the passing lane being open, and so on). In various embodiments, the allowable TTC window 506 is affected by both the coefficient of friction of the roadway as well as a current percentage of overlap between the vehicle 100 and the other vehicle 304 (e.g., as the vehicle 100 is currently beginning to overtake the other vehicle 304 as a results of the driver's steering input).

For example, in certain embodiments, a relatively smaller coefficient of friction would allow for a larger maximum TTC 502 and minimum TTC 504 thereby moving the allowable TTC window 506 to the left). Conversely, also in certain embodiments, a relatively larger coefficient of friction may have an opposite effect, and so on.

Also in certain embodiments, when the lateral overlap between the vehicle 100 and the other vehicle 304 is relatively small, then the minimum TTC 504 is reduced, thereby allowing the driver's engagement of the steering intent relatively closer to the detected vehicle 304. Conversely, also in certain embodiments, when the lateral overlap between the vehicle 100 and the other vehicle 304 is relatively large, then the minimum TTC 504 is increased, thereby requiring the driver's engagement of the steering intent to be relatively farther from the detected vehicle 304 (i.e., requiring the driver intent to occur relatively earlier in time).

With reference to FIG. 6, an illustration 600 is provided with additional details as to the TTC window 506 of FIG. 5, in accordance with an exemplary embodiment. Specifically, in accordance with an exemplary embodiment, the illustration 600 of FIG. 6 depicts both a high speed TTC window 610 and a low speed TTC window 612. In various embodiments, the high speed TTC window 610 is utilized when the vehicle 100 is travelling at a speed that is greater than a predetermined speed threshold, whereas the low speed TTC window 612 is utilized when the vehicle 100 is travelling at a speed that is less than or equal to the predetermined speed threshold. In one exemplary embodiment the predetermined speed threshold is equal to approximately twenty miles per hour; however, this may vary in other embodiments.

With further reference to FIG. 6, in various embodiments a forward contact warning (FWC) 602 and/or contact imminent braking warning (CIB) 604 are provided, along with an emergency panic braking warning 608, for example as provided via the control system 102 and/or one or more other safety systems of the vehicle 100. In various embodiments, these warnings provide an indication that some driver intervention is needed in order to avoid contact with the other vehicle 304. Also in certain embodiments, one or more of these warnings can serve as an applicable beginning point for the TTC window.

In certain embodiments, at relatively higher speeds (e.g., above the predetermined speed threshold referenced above), such warnings (e.g., the FCW warning 602 and/or CIB warning 604) may actually occur subsequent to the theoretical value in order to avoid false triggers. However, with respect to the current application, given that driver initiation is required before implementing the evasive steering maneuver, in various embodiments the TTC window may be widened in comparison to such values.

As depicted in FIG. 6, in various embodiments, at relatively high speeds for the vehicle 100, the high speed TTC window 610 may begin at the panic braking warning 608 (and prior to both the FCW warning 602 and the CIB warning 604, and may end at the minimum TTC value 504 (e.g., as described above with respect to FIG. 5). Also as depicted in FIG. 6, in an exemplary embodiment the low speed TTC window 612 may begin between the FCW warning 602 and the CIB warning 604 (i.e., subsequent to the FCW warning 602 and prior to the CIB warning 604), and may also end at the minimum TTC 504.

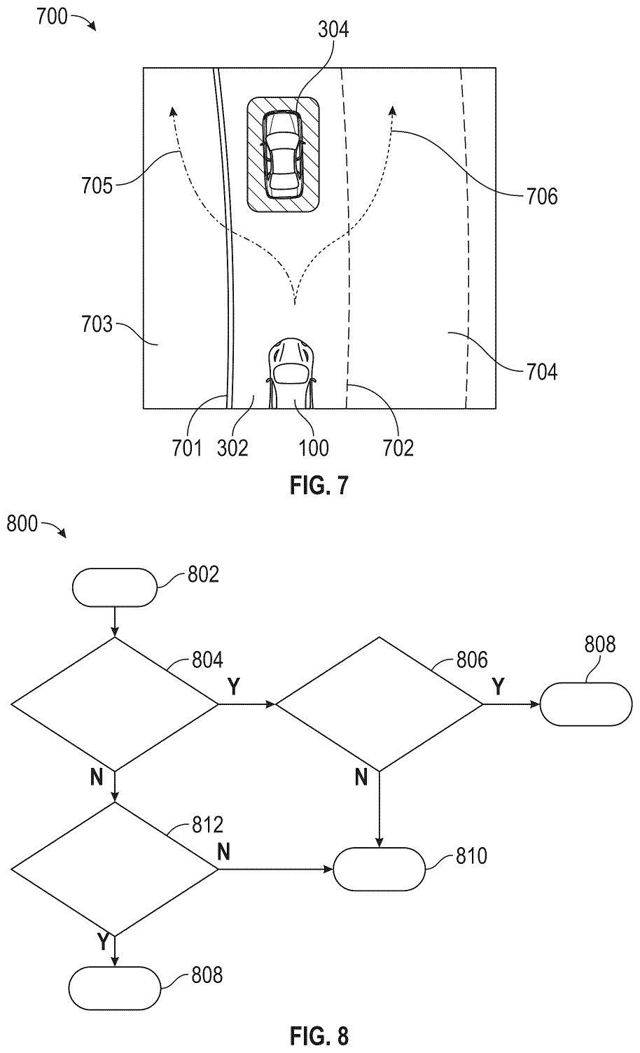

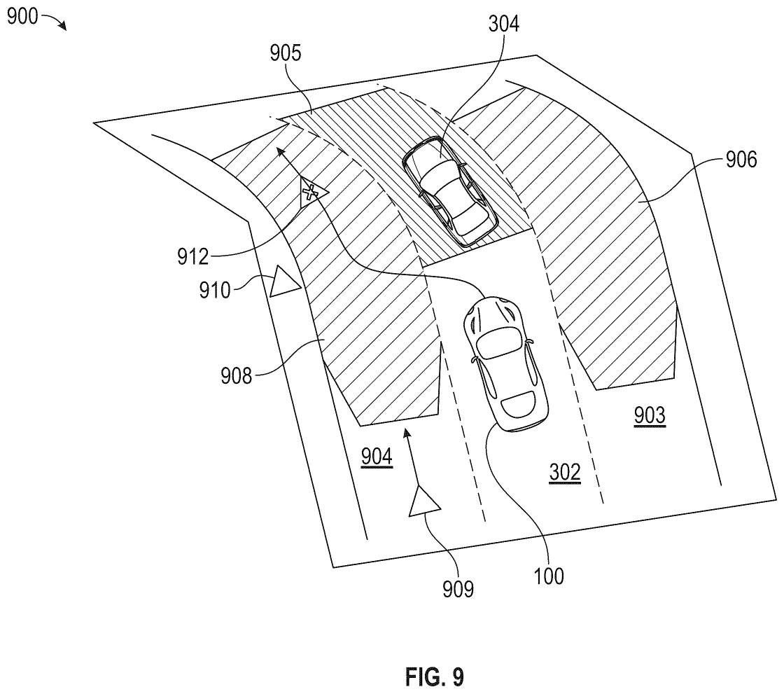

With reference to FIGS. 7 and 8, respective illustrations 700 and 800 are provided with respect to the lane topology assessor of step 212 of FIG. 2, in accordance with an exemplary embodiment.

As depicted in illustration 700 of FIG. 7, the vehicle 100 is depicted in its current lane 302 in proximity to the detected other vehicle 304. Also as depicted in FIG. 7, the current lane 302 is surrounded by a first lane marker 701 and a second lane marker 702. The first lane marker 701 separates the current lane 302 from a first adjacent lane 703, whereas the second lane marker 702 separates the current lane 302 from a second adjacent lane 704.

In an exemplary embodiment, the first lane marker 701 provides an indication that the first adjacent lane 703 is not authorized for use by vehicles from the current lane 302. For example, in various embodiments, the first lane marker 701 comprises a yellow lane marker, a solid lane marker, and/or other type of lane marker providing that the vehicle 100 cannot use the first adjacent lane 703 for passing. Accordingly, in an exemplary embodiment, a possible trajectory 705 into the first adjacent lane 703 is ruled out for passing, such that no assistance for steering will be provided along this trajectory 705.

Also in an exemplary embodiment, the second lane marker 702 provides an indication that the second adjacent lane 704 is authorized for use by vehicles from the current lane 302. For example, in various embodiments, the second lane marker 702 comprises a dashed or dotted white lane marker, and/or other type of lane marker providing that the vehicle 100 can use the second adjacent lane 704 for passing. Accordingly, in an exemplary embodiment, a possible trajectory 706 into the second adjacent lane 704 is allowed for passing, such that assistance for steering will be provided along this trajectory 706 (provided that other conditions are also satisfied, such as the second adjacent lane 704 being unoccupied or clear for use as a passing lane for the vehicle 100 to pass the other vehicle 304, and so on).

With reference now to FIG. 8, a flowchart is provided for the lane topology assessor of step 212 of FIG. 2, in accordance with an exemplary embodiment, beginning with step 802 (e.g., when passing using an adjacent lane is being considered).

In an exemplary embodiment, a determination is made at step 804 as to whether the evasive steering maneuver would potentially cause the vehicle 100 to enter a lane with traffic flowing in an opposite direction as the vehicle 100. For example in a first embodiment in which the vehicle 100 is operating in a region in which vehicles travel in the right lane, the determination of step 804 would include a determination as to whether the evasive steering maneuver would take the vehicle 100 into a left adjacent lane. By way of additional example in accordance with a second embodiment in which the vehicle 100 is operating in a region in which vehicles travel in the left lane, the determination of step 804 would include a determination as to whether the evasive steering maneuver would take the vehicle 100 into a right adjacent lane.

In various embodiments, if it is determined in step 804 that the evasive steering maneuver would cause the vehicle 100 to potentially enter a lane with traffic flowing in an opposite direction as the vehicle 100, then the process proceeds to step 806, described below.

In various embodiments, during step 806, a determination is made as to whether the evasive steering maneuver would cause the vehicle 100 to cross a lane marker indicating traffic flow in the opposite direction of the vehicle 100 (e.g., a yellow lane marker).

In various embodiments, if it is determined in step 806 that the evasive steering maneuver would cause the vehicle 100 to cross a lane marker indicating traffic flow in the opposite direction of the vehicle 100 (e.g., a yellow lane marker), then the process proceeds to step 808, as a “fail” indicator is determined. In various embodiments, the “fail” indicator means that steering assistance will not be provided by the control system 102 into the adjacent lane (e.g., across the yellow lane marker).

Conversely, if it is instead determined in step 806 that the evasive steering maneuver would not cause the vehicle 100 to cross a lane marker indicating traffic flow in the opposite direction of the vehicle 100 (e.g., the lane marker is a white lane marker, rather than a yellow lane marker), then the process proceeds to step 810, as a “pass” indicator is determined. In various embodiments, the “pass” indicator means that steering assistance may be provided by the control system 102 into the adjacent lane (e.g., across the white lane marker).

With reference back to step 804, if it is instead determined in step 804 that the evasive steering maneuver would not cause the vehicle 100 to potentially enter a lane with traffic flowing in an opposite direction as the vehicle 100, then the process proceeds instead to step 812, described below.

In various embodiments, during step 810, a determination is made as to whether the evasive steering maneuver would cause the vehicle 100 to cross into a road shoulder.

In various embodiments, if it is determined in step 810 that the evasive steering maneuver would cause the vehicle 100 to cross into a road shoulder, then the process proceeds to the above-referenced step 808, as a “fail” indicator is determined (i.e., so that assistance will not be provided by the control system 102).

Conversely, in various embodiments, if it is instead determined in step 810 that the evasive steering maneuver would not cause the vehicle 100 to cross into a road shoulder, then the process proceeds instead to the above-referenced step 810, in which a “pass” indicator is determined (i.e., so that steering assistance will be provided by the control system 102 to execute the desired evasive steering maneuver).

With reference now to FIG. 9, an illustration 900 is provided with respect to the assessment of a side zone threat in implementing the process 200 of FIG. 2, in accordance with an exemplary embodiment.

As depicted in FIG. 9, in an exemplary embodiment, the vehicle 100 is depicted in its current lane 302 along with the detected other vehicle 304. In the embodiment of FIG. 9, there are two possible adjacent lanes for passing, namely: a right lane 903 and a left lane 904. In the depicted embodiment, the right lane 903 includes a right threat zone 906 that is examined by the control system 102 for passing purposes. Similarly, also as depicted in FIG. 9, the left lane 904 includes a left threat zone 908 that is examined by the control system 102 for passing purposes. Finally, the illustration 900 of FIG. 9 also shows an avoidance zone 905 in the current lane 302 that should be avoided by the vehicle 100 as it returns to the current lane 302 after passing the other vehicle 304.

In various embodiments, each of the respective zones 906, 908, and 905 are examined by the control system 102 based on the geometry of the roadway, along with path trajectories of the vehicle 100, the other vehicle 304, and any additional vehicles that may also be travelling along the roadway. In various embodiments, a particular zone 906, 908, and/or 905 is determined to be not clear for use if any of the following conditions are present: (i) a threat exists in a region of interest corresponding to the zone; (ii) a threat is projected to enter the region of interest during the steering maneuver; and/or (iii) the region of interest has or is projected to have another vehicle or object within it during the steering maneuver.

For example, with reference to FIG. 9, in an exemplary embodiment: (i) a first additional vehicle 909 would potentially be considered a threat, particular if it has a sufficiently high relative velocity with respect to the vehicle 100; (ii) a second additional vehicle 910 would not be considered a threat, as it is travelling outside each of the zones of interest; and (iii) a third additional vehicle 912 would be considered a threat due to its position in the left threat zone 908.

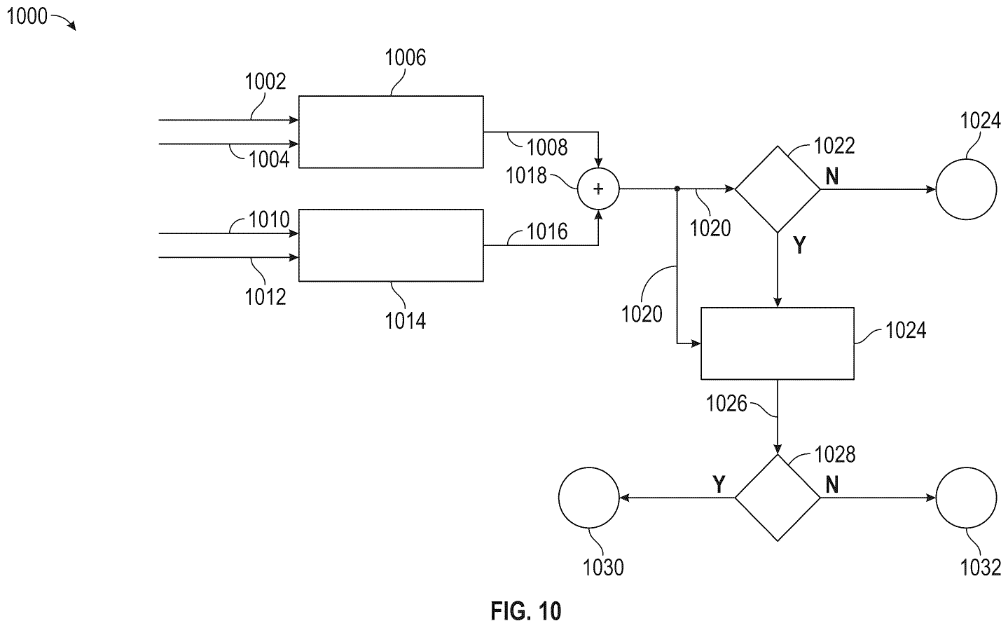

With reference now to FIG. 10, an exemplary flowchart 1000 is provided with respect to the host dynamics assessor of step 208 of FIG. 2. As depicted in FIG. 10, in an exemplary embodiment, a time to contact “t” (e.g., between the vehicle 100 and the other vehicle 304) is calculated at step 1002. In addition, a lateral overlap “w” is calculated at step 1004 (also, e.g., between the vehicle 100 and the other vehicle 304). In various embodiments, the time to contact “t” and the lateral overlap “w” are utilized together by the processor 142 in step 1006 for calculating the lateral acceleration “a_{y}” required for evasion (i.e., for the vehicle 100 to avoid contact with the other vehicle 304). In various embodiments, the calculation results in the evasion lateral acceleration “a_{y}” 1008.

Also in various embodiments, additional calculations are made by the processor 142, based on the sensor data, as to the lane curvature “x” of the roadway (step 1010) and the velocity (speed) “v” of the vehicle 100 (step 1012). In various embodiments, during step 1014, the processor 142 utilizes both the lane curvature “x” and the vehicle speed “v” to calculate a lane keeping acceleration “a_{y}” 1016 that is required for the vehicle 100 to keep in its intended lane.

In various embodiments, the evasion lateral acceleration 1008 and the lane keeping acceleration 1016 are added together at step 1018, thereby yielding a total required lateral acceleration 1020.

In various embodiments, during step 1022, a determination is made as to whether the total required lateral acceleration 1020 is less than a predetermined threshold. If it is determined in step 1022 that the total required lateral acceleration is greater than or equal to the predetermined threshold, then a “fail” indication is provided at step 1024 (meaning that steering assistance is not provided by the control system 102).

Conversely, if it is instead determined in step 1022 that the total required lateral acceleration is less than the predetermined threshold, then a de-boost curve is initiated for an electric power steering (EPS) system for the vehicle 100 (step 1024), using the total required lateral acceleration 1020. In various embodiments, step 1024 results in a peak steering torque required (T) 1026 for the steering maneuver.

In various embodiments, a determination is made during step 1028 as to whether the peak steering torque required (T) is less than a threshold (e.g., corresponding to a Tₘₐₓ value). In various embodiments, if it is determined that the peak steering torque required (T) is less than the threshold, then a “pass” indication is provided at step 1030 (e.g., steering assistance is provided by the control system 102 in completing the evasive steering maneuver). Conversely, if it is instead determined that the peak steering torque required (T) is greater than or equal to the threshold, then a “fail” indication is provided at step 1032 (e.g., steering assistance is not provided by the control system 102 in completing the evasive steering maneuver).

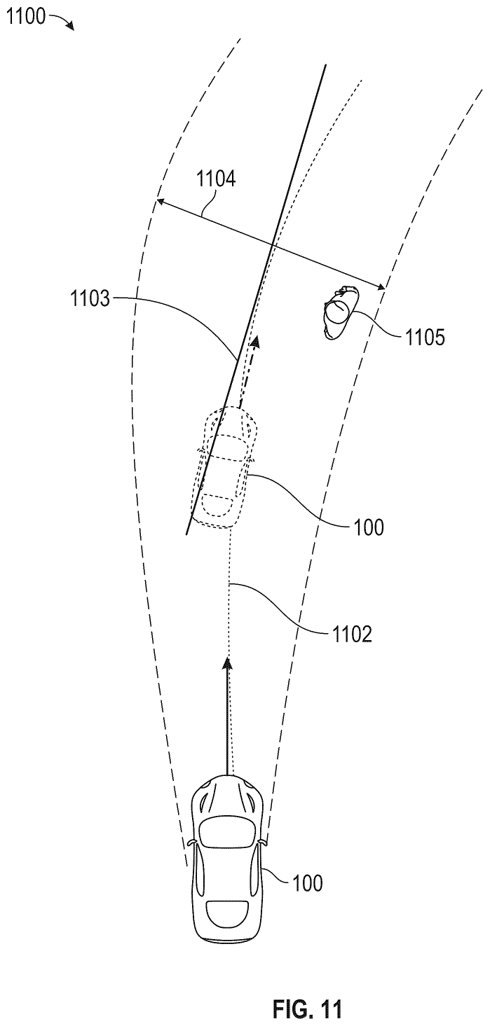

With reference now to FIG. 11, an exemplary illustration 1100 is provided with respect to the VRU assessor of step 214 of FIG. 2. In various embodiments, as depicted in FIG. 11, an estimated path 1102 of the vehicle 100 is determined based on vehicle dynamics (e.g., heading, speed, acceleration, and steering angle of the vehicle 100). Also in various embodiments, a line 1103 is drawn tangential to the estimated path 1102 of the vehicle 100. In an exemplary embodiment, an estimated path error 1104 (e.g., distance from the vehicle 100) is calculated, and is compared with a distance from a vulnerable road user 1105 to the tangential line 1103. In various embodiments, if the distance from the vulnerable road user 1105 to the tangential line is less than a predetermined threshold, then the control system 102 may engage with implementing the evasive steering maneuver. In certain embodiments, the predetermined threshold may be equal to or otherwise based upon the path error 1104. Conversely, in various embodiments, if the distance from the vulnerable road user 1105 to the tangential line is greater than or equal to the predetermined threshold (e.g., the path error 1104, in certain embodiments), then the control system 102 does not engage with implementing the evasive steering maneuver.

Accordingly, methods, systems, and vehicles are provided for selectively automatically completing an evasive steering maneuver upon initiation by a driver of the vehicle, based on various conditions, parameters, and determinations are described in greater detail above and in the Figures.

It will be appreciated that the systems, vehicles, and methods may vary from those depicted in the Figures and described herein. For example, the vehicle 100 of FIG. 1, including the control system 102 and/or other components thereof, may vary in different embodiments from that depicted in FIG. 1 and/or described above in connection therewith. It will similarly be appreciated that the steps of the process 200 and implementations thereof may differ from those depicted in FIGS. 2-11, and/or that various steps of the process 200 may occur concurrently and/or in a different order than that depicted in FIGS. 2-11 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of completing an evasive steering maneuver for a vehicle around an object, the method comprising:
detecting the object, via one or more detection sensors of the vehicle;
obtaining, via one or more input sensors of the vehicle, an input reflecting a driver's intent to initiate the evasive steering maneuver for the vehicle around the object;
obtaining, via one or more additional sensors, additional sensor data pertaining to operation of the vehicle and further pertaining to a roadway on which the vehicle is travelling;
performing, via a processor of the vehicle, a plurality of assessors for the vehicle, each of the plurality of assessors pertaining to different conditions pertaining to the evasive steering maneuver, using the additional sensor data; and
selectively completing the evasive steering maneuver, automatically in accordance with instructions provided by the processor, based on the plurality of assessors and the different conditions pertaining thereto.

2. The method of claim 1, wherein the step of selectively completing the evasive steering maneuver comprises selectively completing the evasive steering maneuver automatically in accordance with instructions provided by the processor, based on the plurality of assessors and the different conditions pertaining thereto, by instructions provided by the processor that are implemented via a steering system, a drive system, and a braking system of the vehicle.

3. The method claim 1, wherein the object comprises one or more other vehicles in proximity to the vehicle.

4. The method of claim 1, wherein the object comprises one or more vulnerable road users (VRU) comprising one or more pedestrians, cyclists, or animals.

5. The method of claim 1, wherein the step of obtaining the input reflecting the driver's intent to initiate the evasive steering maneuver for the vehicle around the object is obtained via one or more steering sensors of the vehicle, based on the driver's engagement of a steering wheel of the vehicle.

6. The method of claim 1, wherein the step of obtaining the input reflecting the driver's intent to initiate the evasive steering maneuver for the vehicle around the object is obtained via one or more cameras configured to capture images of one or more actions taken by a driver of the vehicle.

7. The method of claim 1, wherein:
the step of performing the plurality of assessors comprises performing, via the processor, each of the following assessors: an allowable passing window assessor, a vehicle dynamics assessor, and one or more additional assessors; and
the step of selectively completing the evasive steering maneuver comprises selectively automatically completing the evasive steering maneuver in accordance with instructions provided by the processor, based on each of the allowable passing window assessor, the vehicle dynamics assessor, and the one or more additional assessors.

8. The method of claim 1, wherein:
the step of performing the plurality of assessors comprises performing, via the processor, each of the following assessors: an allowable passing window assessor; a vehicle dynamics assessor; a lane topology assessor; a vulnerable road user (VRU) assessor; a timely intent assessor; and a scene actor assessor; and
the step of selectively completing the evasive steering maneuver comprises selectively automatically completing the evasive steering maneuver in accordance with instructions provided by the processor, based on each of the allowable passing window assessor, the vehicle dynamics assessor, the lane topology assessor, the vulnerable road user (VRU) assessor, the timely intent assessor, and the scene actor assessor.

9. The method of claim 8, wherein the evasive steering maneuver is automatically completed via instructions provided by the processor if, and only if, a passing indication is provided by each of the allowable passing window assessor, the vehicle dynamics assessor, the lane topology assessor, the vulnerable road user (VRU) assessor, the timely intent assessor, and the scene actor assessor.

10. The method of claim 1, wherein the step of selectively completing the evasive steering maneuver comprises selectively automatically completing the evasive steering maneuver in accordance with instructions provided by the processor, based also on lane markings along the roadway, including as to whether the lane markings provide that passing is allowed on one or more adjacent lanes.

11. The method of claim 1, wherein the step of selectively completing the evasive steering maneuver comprises selectively automatically completing the evasive steering maneuver in accordance with instructions provided by the processor, based also on a time to contact (TTC) window between the vehicle and the detected object that is dependent upon a speed of the vehicle as well as one or more potential contact warnings that are provided by one or more safety systems of the vehicle.

12. The method of claim 1, wherein the step of selectively completing the evasive steering maneuver comprises selectively automatically completing the evasive steering maneuver in accordance with instructions provided by the processor, based also on assessment of one or more side threats to the vehicle as it would undertake the evasive steering maneuver, including as to whether any additional vehicles or other objects, along their respective current trajectories, would be likely to interfere with the evasive steering maneuver for the vehicle.

13. The method of claim 1, wherein the step of selectively completing the evasive steering maneuver comprises selectively automatically completing the evasive steering maneuver in accordance with instructions provided by the processor, based also on both:
a total required lateral acceleration of the vehicle, calculated by the processor as a summation of an evasion lateral acceleration required to evade the object, added to a lane keeping lateral acceleration required to maintain the vehicle in an intended lane of travel; and
a peak steering torque required to execute the evasive steering maneuver, calculated by the processor based on both the total required lateral acceleration along with a de-boost curve for an electric power steering system for the vehicle.

14. The method of claim 1, wherein the step of selectively completing the evasive steering maneuver comprises selectively automatically completing the evasive steering maneuver in accordance with instructions provided by the processor, based also on executing a vulnerable road user (VRU) assessor, including by doing the following, via the processor:
calculating an estimated path of the vehicle;
drawing a tangential line that is tangential to the estimated path of the vehicle;
calculating, via the processor, a distance from a vulnerable road user to the tangential line; and
engaging in completing the evasive steering maneuver, if and only if the distance from the vulnerable road user to the tangential line is less than a predetermined threshold.

15. A system for completing an evasive steering maneuver for a vehicle around an object, the system comprising:
one or more detection sensors of the vehicle that are configured for detecting the object;
one or more input sensors that are configured for obtaining an input reflecting a driver's intent to initiate the evasive steering maneuver for the vehicle around the object;
one or more additional sensors that are configured for obtaining additional sensor data pertaining to operation of the vehicle and further pertaining to a roadway on which the vehicle is travelling; and
a processor that is coupled to the one or more detection sensors, the one or more input sensors, and the one or more additional sensors, the processor configured to at least facilitate:
performing a plurality of assessors for the vehicle, each of the plurality of assessors pertaining to different conditions pertaining to the evasive steering maneuver, using the additional sensor data; and
selectively completing the evasive steering maneuver, automatically in accordance with instructions provided by the processor, based on the plurality of assessors and the different conditions pertaining thereto.

16. The system of claim 15, wherein the processor is further configured to at least facilitate:
performing the plurality of assessors by performing each of the following assessors: an allowable passing window assessor, a vehicle dynamics assessor, and one or more additional assessors; and
selectively automatically completing the evasive steering maneuver in accordance with instructions provided by the processor, based on each of the allowable passing window assessor, the vehicle dynamics assessor, and the one or more additional assessors.

17. The system of claim 15, wherein the processor is further configured to at least facilitate
performing the plurality of assessors by performing each of the following assessors: an allowable passing window assessor; a vehicle dynamics assessor; a lane topology assessor; a vulnerable road user (VRU) assessor; a timely intent assessor; and a scene actor assessor; and
selectively automatically completing the evasive steering maneuver in accordance with instructions provided by the processor, based on each of the allowable passing window assessor, the vehicle dynamics assessor, the lane topology assessor, the vulnerable road user (VRU) assessor, the timely intent assessor, and the scene actor assessor.

18. The system of claim 15, wherein the processor is further configured to at least facilitate selectively automatically completing the evasive steering maneuver in accordance with instructions provided by the processor, based also on both:
a total required lateral acceleration of the vehicle, calculated by the processor as a summation of an evasion lateral acceleration required to evade the object, added to a lane keeping lateral acceleration required to maintain the vehicle in an intended lane of travel; and
a peak steering torque required to execute the evasive steering maneuver, calculated by the processor based on both the total required lateral acceleration along with a de-boost curve for an electric power steering system for the vehicle.

19. The system of claim 15, wherein the processor is further configured to at least facilitate selectively automatically completing the evasive steering maneuver in accordance with instructions provided by the processor, based also on executing a vulnerable road user (VRU) assessor, including by doing the following:
calculating an estimated path of the vehicle;
drawing a tangential line that is tangential to the estimated path of the vehicle;
calculating, via the processor, a distance from the VRU to the tangential line; and
engaging in completing the evasive steering maneuver, if and only if the distance from the VRU to the tangential line is less than a predetermined threshold.

20. A vehicle comprising:
a steering system;
a drive system;
a braking system;
one or more detection sensors that are configured for detecting an object in proximity to the vehicle;
one or more input sensors that are configured for obtaining an input reflecting a driver's intent to initiate an evasive steering maneuver for the vehicle around the object;
one or more additional sensors that are configured for obtaining additional sensor data pertaining to operation of the vehicle and further pertaining to a roadway on which the vehicle is travelling; and
a processor that is coupled to the one or more detection sensors, the one or more input sensors, the one or more additional sensors, the steering system, the drive system, and the braking system, the processor configured to at least facilitate:
performing a plurality of assessors for the vehicle, each of the plurality of assessors pertaining to different conditions pertaining to the evasive steering maneuver, using the additional sensor data; and
selectively completing the evasive steering maneuver, automatically in accordance with instructions provided by the processor and that are executed by the steering system, the drive system, and the braking system, based on the plurality of assessors and the different conditions pertaining thereto.
